(19) United States
(12) Patent Application Publication
(10) Pub. No.: US 2025/0302254 A1
(43) Pub. Date: Oct. 2, 2025

(54) SUCTION APPARATUS AND SEPARATING UNIT FOR A SUCTION APPARATUS WITH A HELICAL DIVERSION ELEMENT

(71) Applicant: BSH Hausgeräte GmbH, München (DE)

(72) Inventors: Juri GEBEL, Hohenroth (DE); Christofer EBERT, Marktheidenfeld (DE); Andre MICHAELIS, Salz (DE); Jens REINHARDT, Hohenroth (DE)

(21) Appl. No.: 19/093,575

(22) Filed: Mar. 28, 2025

(30) Foreign Application Priority Data
Mar. 28, 2024 (DE) 10 2024 203 007.4

(51) Int. Cl. A47L 9/16; A47L 5/22; A47L 9/10; A47L 9/12

(52) U.S. Cl. CPC A47L 9/165; A47L 5/22; A47L 9/102; A47L 9/108; A47L 9/125

(57) ABSTRACT

A separating unit for a suction apparatus includes a collecting container surrounded by a housing wall extending along a longitudinal axis and having an inlet opening for a suction air flow. The separating unit causes the suction air flow entering through the inlet opening into the collecting container to have a flow direction in a circumferential direction relative to the longitudinal axis. An annular diversion element has a surface acting on the suction air flow entering into the collecting container. The surface of the diversion element, at least partially, runs helically along the inside of the housing wall around the longitudinal axis. The surface of the diversion element has a step with first and second edges mutually spaced apart along the longitudinal axis. The step of the surface runs at an angle relative to the longitudinal axis. A suction apparatus having the separating unit is also provided.

### CROSS-REFERENCE TO RELATED APPLICATION

This application claims the priority, under 35 U.S.C. § 119, of German Patent Application DE 10 2024 203 007.4, filed Mar. 28, 2024; the prior application is herewith incorporated by reference in its entirety.

### FIELD AND BACKGROUND OF THE INVENTION

The invention relates to a separating unit for a suction apparatus, in particular for a cordless and/or handheld vacuum cleaner. The invention also relates to a suction apparatus having a separating unit.

A suction apparatus, in particular a handheld vacuum cleaner, typically includes a suction unit, which can be manually held and guided by a user. The suction unit has a fan which is operated by electrical energy from an electrical energy source of the suction unit. The fan is embodied to create a flow of suction air in order to suck contaminations through the suction nozzle of the suction unit into the separating unit of the suction unit, where the separating unit has a collecting container for contaminations. In order to increase the suction power of the suction unit, the flow of suction air is preferably guided into the separating unit and/or within the separating unit in such a way that the flow of suction air within the separating unit flows in the manner of a cyclone around the central filter unit of the separating unit.

Chinese Patent Application CN 1 13 171 028 A describes a separating unit for a vacuum cleaner.

### SUMMARY OF THE INVENTION

It is accordingly an object of the invention to provide a suction apparatus and a separating unit for a suction apparatus with a helical diversion element, which overcome the hereinafore-mentioned disadvantages of the heretofore-known devices of this general type and which further optimize the direction of flow of the flow of suction air within the separating unit of a suction unit, in particular to bring about a permanently high suction power even with prolonged usage of the suction unit.

With the foregoing and other objects in view there is provided, in accordance with the invention, a separating unit for a suction apparatus, the separating unit comprising a collecting container surrounded by a housing wall, the collecting container extends along a longitudinal axis, the housing wall of the collecting container runs cylindrically, in particular circular cylindrically, around the longitudinal axis, the collecting container has an inlet opening disposed on the housing wall for a flow of suction air, the separating unit is embodied in such a way that a flow of suction air entering through the inlet opening into the collecting container has a direction of flow running in a circumferential direction in relation to the longitudinal axis, the separating unit includes an annular diversion element, which has a surface that acts on the flow of suction air entering into the collecting container, the surface of the diversion element, at least in a partial area, runs in the shape of a helix along the inside of the housing wall around the longitudinal axis, so that the surface of the diversion element has a step with a first edge and a second edge, which are spaced apart from one another along the longitudinal axis, and the step of the surface runs at an angle to the longitudinal axis.

Advantageous forms of embodiment are defined in particular in the dependent claims, described in the description below or shown in the enclosed drawing.

In accordance with one aspect a separating unit for a suction apparatus is described. The separating unit includes a collecting container surrounded by a housing wall. The separating unit can have a longitudinal axis, and the housing wall of the collecting container can be embodied in the form of a (circular) cylinder around the longitudinal axis. The longitudinal axis can run centrally within the collecting container. The housing wall can for example correspond to the outer surface of a hollow cylinder and/or the longitudinal axis can correspond to the vertical axis of the hollow cylinder. The collecting container can extend from a first end face (for example end-face surface or end-face plane) along the longitudinal axis up to a second end face (for example end-face surface or end-face plane). The first end face can face toward the fan of the suction apparatus. A lid for emptying the collecting container can be disposed on the opposite second end face.

The collecting container can have a specific overall length along the longitudinal axis from the first end face to the second end face (for example between 10 cm and 20 cm). The collecting container can have a specific overall diameter (for example between 8 cm and 12 cm) transverse to the longitudinal axis (i.e. in the radial direction relative to the longitudinal axis).

The first end face (on which the fan is disposed) can substantially run completely within a specific transverse plane, which is disposed at right angles to the longitudinal axis. The second end face (on which the lid is disposed) can run within a plane that is disposed at right angles to the longitudinal axis, wherein the angled arrangement of the second end face and in particular of the lid can be advantageous for emptying the collecting container.

The collecting container has an inlet opening disposed on the housing wall, which is preferably closed and/or covered by a (flexible) flap. The flap can be made of a plastic, in particular a flexible and/or elastic plastic. The inlet opening is preferably disposed on the upper side of the collecting container (which is intended to be oriented upward during operation). The inlet opening is further preferably disposed on the first end face of the collecting container. The inlet opening, at least along the longitudinal axis, is preferably closer to the first end face of the collecting container than to the opposite second end face of the collecting container.

The separating unit can further include a filter unit disposed in the collecting container, which is embodied to hold back particles of dirt from the flow of suction air (entering the collecting container through the inlet opening) on the surface of the filter unit, wherein the surface of the filter unit is preferably embodied (circular) cylindrically in shape around the longitudinal axis. The separating unit is preferably embodied in such a way that the flow of suction air entering the collecting container through the inlet opening flows cyclonically (in the circumferential direction) around the filter unit. For this purpose the separating unit can be embodied in such a way that the flow of suction air entering the collecting container through the inlet opening has a direction of flow that runs substantially in the circumferential direction around the longitudinal axis.

The (cylindrical) filter unit and the (cylindrical) collecting container preferably have the same central longitudinal axis. The collection area for accommodating the sucked-in dirt particles is typically disposed between the surface of the filter unit and the inside of the collecting container.

The flap on the inlet opening can have a (rectangular) overall surface for (completely) covering the (rectangular) inlet opening. The flap and the inlet opening can each have two longitudinal edges (disposed opposite one another in the circumferential direction) and two transverse edges (disposed opposite one another along the longitudinal axis). The flap can be fastened to the housing wall on a main edge. The main edge can be oriented in parallel with the longitudinal axis (i.e. the main edge can correspond to a longitudinal edge). On the other hand the flap can be freely movable on the two transverse edges and on the other longitudinal edge (so that the flap can bend away from the inlet opening into the collecting container in order to open or release a partial area of the inlet opening).

The flap has a first partial area and a second partial area following it along the main edge (in particular along the longitudinal axis). The first partial area of the flap can face toward the first end face of the collecting container (and the first transverse edge of the flap), and the second partial area of the flap can face toward the second end face of the collecting container (and the second transverse edge of the flap). As an alternative or in addition, the first partial area of the flap can be closer to the first end face of the collecting container than the second partial area of the flap.

The flexible flap is embodied in such a way that the flap is bent away from the housing wall or away from the inlet opening and/or into the collecting container by a force acting (in the radial direction) from the outside on the flap and, in doing so, releasing the inlet opening, at least in some areas. The flap can be bent toward the surface of the filter unit for example. The force for bending away the flap can be exerted by the flow of suction air flowing from outside through the inlet opening into the collecting container.

The separating unit can be embodied in such way that the bending away of the first partial area of the flap is more heavily restricted and/or limited than the bending away of the second partial area of the flap. In this way, in an efficient and reliable way, an impulse can be exerted (by the flap) on the flow of suction air flowing through the inlet opening, through which the suction power of the suction apparatus and/or the quality of dust separation of the separating unit is improved.

The separating unit is preferably embodied in such a way that the flow of suction air entering through the inlet opening into the collecting container flows (in the circumferential direction) around the longitudinal axis (in particular around the surface of the filter unit). The separating unit can further be embodied in such a way that, by the bending away of the first partial area of the flap being more greatly restricted than the bending away of the second partial area of the flap, the flap is aligned in such a way in relation to the flow of suction air flowing in, that the flow of suction air entering into the collecting container through the inlet opening receives an impulse in the direction of the longitudinal axis. This can bring about that the flow of suction air flows helically around the longitudinal axis within the collecting container. Thus, in an efficient and reliable way, the particles of dirt conveyed along with the flow of suction air are moved away from the inlet opening (to the second end face of the collecting container), by which the suction power and/or the quality of separation can be increased to a particular extent.

The separating unit can have a (mechanical) obstacle (which is disposed within the collecting container), through which the bending away of the first partial area of the flap, and in particular not the bending away of the second partial area of the flap, is selectively restricted. The separating unit can for example have a support surface (formed by the obstacle) for supporting the first partial area of the flap, wherein the support surface is embodied to restrict the bending away of the first partial area of the flap. The support surface can be embodied to accept the rear side of the flap (in the area of the first partial area of the flap), facing away from the inlet opening. In particular the separating unit can be embodied in such a way that the rear side of the first partial area of the flap rests on the support surface when a force is acting from outside in the radial direction on the flap (wherein the force is brought about by the flow of suction air for example).

The provision of a mechanical obstacle enables the flow of suction air circulating within the collecting container around the longitudinal axis to be blocked in some areas in the area of the rear side of the flap (facing toward the collecting container). As a consequence thereof the closure force acting on the rear side of the flap for closing the flap is reduced, through which the required force for opening the flap is reduced. As a consequence thereof the suction power of the suction apparatus can be further increased.

The separating unit is preferably embodied in such a way that the bending away of the second partial area of the flap is substantially not restricted, in particular not restricted by a (mechanical) obstacle. What can be brought about in this way is that the inlet opening can still be opened sufficiently wide for coarse dirt to be accepted.

The separating unit can include an ejection and/or compacting element, which is embodied to be moved within the collecting container in order to compress the particles of dirt disposed in the collecting container and/or to eject them from the collecting container (via the second end face). The ejection and/or compacting element can in particular be embodied, (starting from an initial position, disposed at the first end face for example) to be moved along the longitudinal axis over the surface of the filter unit (in particular toward the second end face of the collecting container).

The ejection and/or compacting element can be embodied to form a (mechanical) obstacle, through which the bending away of the first partial area of the flap (and not of the second partial area of the flap) is restricted. For this purpose the ejection and/or compacting element is preferably disposed, in the initial position (in relation to the longitudinal axis) flush with the first partial area of the flap in the radial direction. The use of the ejection and/or compacting element as an obstacle enables the selective restriction of the freedom of movement of the first partial area of the flap to be bought about in an especially efficient and reliable way.

The ejection and/or compacting element is preferably formed as a ring with an inner edge embodied facing toward the surface of the filter unit and an outer edge facing toward the housing wall. A surface of the ring (which faces toward the second end face of the collecting container) running between the inner edge and the outer edge can be embodied in an efficient and reliable way as a support surface for supporting the first partial area of the flap.

The normal vector of the support surface (standing at right angles to the support surface) can run at an angle to the longitudinal axis. The angle between the longitudinal axis and the normal vector of the support surface preferably amounts to between 10° and 45°. The normal vector of the support surface can further have a directional component, which points outward in the radial direction from the collecting container. A support surface embodied in such a way enables the flap to be aligned in an especially advantageous way in order to bring about a helical flow of suction air within the collecting container.

The (annular) ejection and/or compacting element can have an annular surface, which includes the support surface for the first partial area of the flap. The annular surface of the ejection and/or compacting element can extend in a radial direction from the inner edge up to the outer edge. The annular surface can face toward the second end face of the collecting container. The normal vector of the annular surface, as the angular distance from the support surface can align itself in parallel with the longitudinal axis. The annular surface of the ejection and/or compacting element can thus (in relation to the longitudinal axis) have an angled section (which serves as a support surface for the flexible flap). Outside of the angled section, the annular surface of the ejection and/or compacting element can substantially run within the transverse plane (aligned at right angles to the longitudinal axis). Thus, even if an angled support surface for the flap aligned is provided, a reliable compression and/or ejection function of the ejection and/or compacting elements can continue to be provided.

The flap can have a linear predetermined bending point, through which a bending of the second partial area about an additional bending axis is made possible. The predetermined bending point and/or the additional bending axis can run linearly between the first partial area and the second partial area. A main bending axis of the flap (about the longitudinal axis) can be formed by the main edge of the flap. The predetermined bending point and/or the additional bending axis can be aligned at an angle to the main bending axis.

The predetermined bending point can be implemented as a local (linear) thinning and/or by a locally changed material of the flap. In particular the flap can have a thinner and/or different material locally along the additional bending axis (as opposed to the areas of the flap without a predetermined bending point). The linear predetermined bending point can be embodied in particular as a film hinge, in particular when the flap is formed of a plastic, in particular of a flexible plastic.

The flap can be embodied in such a way that the second partial area of the flap is bent inward into the collecting container around the additional bending axis by a force acting on the second partial area from the outside (in a radial direction). The provision of a flap with a linear predetermined bending point enables the impulse brought about by the flap (along the longitudinal axis) to be further increased in order to bring about a helical flow of suction air in an especially reliable way.

As already stated above, the additional bending axis of the predetermined bending point can run at an angle to the main bending axis (i.e. to the main edge), in particular in such a way that a triangular second partial area is formed by the predetermined bending point. In this way the impulse brought about by the flap (along the longitudinal axis) can be further increased.

In accordance with a further aspect a further separating unit for a suction apparatus is described. As already stated, the separating unit includes a collecting container surrounded by a housing wall. The collecting container can extend along the longitudinal axis from the first end face up to the opposite second end face. A (cylindrical) filter unit can be disposed in the collecting container. The features of the separating unit and in particular of the collecting container described further above are also able to be applied individually or in combination to this separating unit.

The collecting container has an inlet opening disposed on the housing wall for a flow of suction air. The inlet opening is preferably covered by flexible flap (as stated above). The inlet opening is preferably disposed on the first end face of the collecting container. The inlet opening can at least be closer to the first end face of the collecting container along the longitudinal axis than to the opposite second end face of the collecting container.

The separating unit is preferably embodied in such a way that a flow of suction air entering through the inlet opening into the collecting container has a direction of flow running in a circumferential direction in relation to the longitudinal axis. The separating unit can in particular be embodied as a centrifugal separator. For this purpose the direction of flow of the flow of suction air at the inlet opening can have a directional component in the circumferential direction. The direction of flow of the flow of suction air at the inlet opening can further have a (relatively small) directional component in the radial direction. On the other hand the direction of flow of the flow of suction air at the inlet opening typically substantially has no directional component along the longitudinal axis.

The separating unit can include a diversion element, which has a surface that acts on the flow of suction air entering through the inlet opening into the collecting container. The surface of the diversion element can be a embodied as a guide surface for guidance of the flow of suction air. At least a part of the flow of suction air flowing through the inlet opening into the collecting container can thus strike the surface of the diversion element, in particular an angled section of the diversion element. The normal vector of the angled section of the surface of the diversion element can run at an angle to the longitudinal axis. The normal vector of the angled section of the surface of the diversion element preferably has an angle to the longitudinal axis of between 10° and 45°, in particular of between 15° and 25°.

The use of a diversion element with an angled section enables an impulse to be brought about on the flow of suction air flowing through the inlet opening, through which the suction power of the suction apparatus and/or the dust separation quality of the separating unit can be improved.

The angled section of the surface of the diversion element can in particular be aligned in such a way that the flow of suction air entering through the inlet opening into the collecting container receives an impulse in the direction of the longitudinal axis. This can bring about the flow of suction air within the collecting container flowing helically around the longitudinal axis. Thus the particles of dirt conveyed along with the flow of suction air are moved away from the inlet opening (to the second end face of the collecting container) in an efficient and reliable way, by which the suction power and/or the quality of separation can be increased to a particular extent.

The angled section of the surface of the diversion element is preferably disposed in the radial direction flush with the inlet opening in relation to the longitudinal axis (in particular with the first end face facing toward the first transverse edge of the inlet opening). An impulse on the flow of suction air in the direction of flow directly behind the inlet opening can thus be brought about in order to create the helical flow of suction air in an especially reliable way.

The surface of the diversion element can be embodied in such a way that the normal vector of the surface of the diversion element, increasing with an increasing distance along the direction of flow of the flow of suction air, is aligned, in particular fluidly, in parallel with the longitudinal axis, in particular in such a way that the normal vector of the surface of the diversion element, as from a predefined distance, is aligned parallel to the longitudinal axis. The fluid change in the alignment of the surface of the diversion element enables the direction of flow of the flow of suction air to be oriented in an especially efficient way (in particular without causing any turbulences) toward the longitudinal axis.

The normal vector of the angled section of the surface of the diversion element preferably has a directional component, which points in a radial direction out of the collecting container. A surface embodied in such a way enables a helical flow of suction air to be brought about within the collecting container in an especially reliable way.

The normal vector of the angled section of the surface of the diversion element is preferably aligned toward the second end face of the collecting container. In this way a helical flow of suction air within the collecting container toward the second end face of the collecting container can be brought about in an especially reliable way.

It should be pointed out that at least one partial area of the angled section of the surface of the diversion element can serve as a support surface for the flexible flap of the separating unit (as stated further above). A change in the direction of flow of the flow of suction air can thus be brought about in an especially reliable way.

As already stated, the housing wall of the collecting container preferably runs in the shape of a cylinder, in particular in the shape of a circular cylinder, around the longitudinal axis. The diversion element can run in the shape of a ring along the inside of the housing wall around the longitudinal axis. In this case the annular diversion element can have an outer edge facing toward the housing wall and an inner edge facing away from the housing wall, in particular facing toward the filter unit of the separating unit.

The surface of the diversion element can be disposed at a first angular position in relation to the longitudinal axis in the radial direction flush with the inlet opening (in particular with the first transverse edge of the inlet opening). The angled section of the surface of the diversion element can thus be disposed in the area of the first angular position (for example starting from the first angular position). The first angular position can have the value 0° for example.

The inner edge can have an inner edge distance at the first angular position with a first distance value from a reference plane disposed at right angles to the longitudinal axis (wherein the reference plane corresponds for example to the rear side of the diversion element facing away from the surface of the diversion element). The outer edge at the first angular position can have an outer edge distance with a second distance value from the reference plane. The first distance value can be smaller than the second distance value.

As already stated, the collecting container can have a specific overall length from the first end face to the second end face. The second distance value can for example be between 0.5% and 2% of the overall length higher or greater that the first distance value. In this way the angled section of the surface of the diversion element can be provided in an especially reliable way.

The inner edge distance and the outer edge distance can converge, in particular fluidly, as the angular distance increases, so that the inner edge distance and the outer edge distance have the same distance value, in particular the first distance value as from a second angular position. The second angular position (in the circumferential direction) is preferably spaced apart from the first angular position by between 70° and 110°, by roughly 90°. The convergence of the distance value enables the normal vector of the surface of the diversion element gradually to be aligned in parallel with the longitudinal axis. In this way an especially reliable change in the direction of flow of the flow of suction air can be brought about.

The inner edge distance and the outer edge distance, as from the second angular position, can have the same distance value in each case. In this case the shared distance value can (fluidly) increase as the angular distance from the second angular position increases, in particular in such a way that the inner edge distance and the outer edge distance have a third distance value at a third angular position. The third angular position can for example be spaced by between 350° and 360°, between roughly 353° and 359°, away from first angular position. The third distance value can be higher or greater than the first distance value by 5% or more, in particular between 5% and 20%, of the overall length of the collecting container.

The surface of the annular diversion element can have a step between the third angular position and the first angular position, at which the distance value of the inner edge distance and of the outer edge distance is (abruptly) reduced to the second distance value or to the first distance value.

A diversion element can thus be provided that has a ramp-shaped surface (in the circumferential direction), which acts on the flow of suction air in the collecting container (and thus serves as a guide surface for the flow of suction air). A helical flow of suction air can thus be brought about in an especially reliable way.

As already stated, the separating unit can include an (annular) ejection and/or compacting element, which is embodied to be moved within the collecting container in order to compress the particles of dirt disposed in the collecting container and/or to eject them from the collecting container. The ejection and/or compacting element can be embodied in particular (starting from the initial position disposed on the first end face for example) to be moved along the longitudinal axis over the surface of the filter unit (in particular toward the second end face of the collecting container). The ejection and/or compacting element, in its initial position, is preferably disposed in the radial direction (in relation to the longitudinal axis) flush with the inlet opening (in particular with the first transverse edge of the inlet opening).

In a preferred embodiment the ejection and/or compacting element is embodied as a diversion element, which has a surface that acts on the flow of suction air. In other words the diversion element can be embodied as an (annular) ejection and/or compacting element. In this way the direction of flow of the flow of suction air can be brought about in an especially efficient way.

In accordance with a further aspect, a further separating unit for a suction apparatus is described. As already stated, the separating unit includes a (cylindrical) collecting container surrounded by a housing wall. The collecting container extends along the longitudinal axis from the first end face to the opposite second end face. A (cylindrical) filter unit can be disposed in the collecting container. The features of the separating unit and in particular of the collecting container described further above are also able to be applied individually or in combination to this separating unit.

The collecting container has an inlet opening for a flow of suction air disposed on the housing wall. The inlet opening is preferably covered by a flexible flap (as stated further above). The inlet opening is preferably disposed at the first end face of the collecting container. The inlet opening can at least be closer to the first end face of the collecting container along the longitudinal axis than to the opposite second end face of the collecting container.

The separating unit is preferably embodied in such a way that a flow of suction air entering through the inlet opening into the collecting container has a direction of flow running in a circumferential direction in relation to the longitudinal axis. The separating unit can be embodied in particular as a centrifugal separator. For this purpose, the direction of flow of the flow of suction air at the inlet opening can have a directional component in the circumferential direction. The flow direction of the flow of suction air at the inlet opening can further have a (relatively small) directional component in the radial direction. On the other hand, the flow direction of the flow of suction air at the inlet opening typically substantially has no directional component along the longitudinal axis.

The separating unit can include an (annular) diversion element, which has a surface that acts on the flow of suction air entering through the inlet opening into the collecting container. At least a part of the flow of suction air flowing in through the inlet opening into the collecting container can thus strike the surface of the diversion element. The surface of the diversion element can be embodied as a guide surface for guiding the flow of suction air.

The surface of the (annular) diversion element, at least in a part section, can run in a helix and/or in a spiral along the inside of the housing wall around the longitudinal axis, so that the surface of the diversion element has a step with a first edge and a second edge, wherein the first edge and the second edge are spaced apart from one another along the longitudinal axis. The height of the helix and/or spiral shape can run along (in particular parallel to) the longitudinal axis. The height can further correspond to the height of the step between the first edge and the second edge. The second edge can be for example be spaced apart by 5% or more, in particular between 5% and 20%, of the overall length of the collecting container along the longitudinal axis from the first edge (i.e. the height of the helix and/or spiral shape can correspond to 5% or more, in particular to between 5% and 20%, of the overall length of the collecting container).

By the provision of a helical and/or spiral guide surface for the flow of suction air entering into the collecting container an impulse on the flow of suction air in the direction of the longitudinal axis can be brought about an in an efficient and reliable way. This can bring about that the flow of suction air within the collecting container flows helically around the longitudinal axis. Thus, in an efficient and reliable way, the particles of dirt carried along with the flow of suction air can be moved away from the inlet opening (toward the second end face of the collecting container), by which the suction power and/or the separation quality can be increased.

The step of the surface of the diversion element preferably runs at an angle to the longitudinal axis. In particular the step of the surface of the diversion element can have an angle to the longitudinal axis of between 1° and 7°, in particular between 2° and 6°, of roughly 5°. An angled step enables turbulences to be avoided at the (second) edge of the step in a reliable way, by which the suction power and/or the separation quality of the separating unit can be further increased.

The surface of the diversion element can be rounded at the first edge and/or at the second edge respectively in the circumferential direction (with a specific rounding radius for example). The rounding of the first and/or of the second edge enables turbulences of the flow of suction air at the step to be avoided in an especially reliable way, by which the suction power and/or the separation quality of the separating unit can be further increased.

As already stated, the diversion element can be embodied in an annular shape (around the longitudinal axis). The step, in particular the first edge of the step, can be disposed at a specific angular position in relation to the longitudinal axis. This angular position can be referred to as the first angular position (and can correspond to 0° for example). The surface of the diversion element, starting from the first angular position, can run (precisely once) around the longitudinal axis (and can thus cover an angular range of 360°).

The surface of the diversion element (in particular the first edge of the step) at the first angular position in relation to the longitudinal axis can be disposed in the radial direction flush with the inlet opening, in particular flush with the first end face facing toward the first transverse edge of the (rectangular) inlet opening. The surface of the diversion element can subsequently be displaced increasingly along the longitudinal axis toward the second end face relative to the first angular position as the angular distance from the first angular position increases, so that the helical surface of the diversion element is formed.

As already stated, the first edge of the step can be disposed at the first angular position. The second edge of the step can be disposed at an angular position that is referred to in this document as the fourth angular position. The fourth angular position and the first angular position can be spaced apart from one another by 2° or more, roughly by between 2° and 7°, for example by 5°. The surface of the diversion element, in particular the outer edge of the surface of the diversion element facing toward the inside of the housing wall, can substantially run in a straight line from the second edge at the fourth angular position to the first edge at the first angular position. In this way the angled step of the diversion element can be provided in an especially reliable way.

The surface of the diversion element, as from a second angular position, with an increasing angular distance from the second angular position up to a third angular position, can be increasingly displaced along the longitudinal axis toward the second end face, so that the helical surface is formed. The second angular position can be spaced apart (in the circumferential direction) by between 70° and 110°, by roughly 90°, from the first angular position. The third angular position can be spaced apart (in the circumferential direction) by between 1° and 15° from the first angular position, in particular from the first angular position increased by 360°. The surface of the diversion element can have a constant incline that stays the same in the circumferential direction between the second angular position and the third angular position. In this way an especially reliable and efficient diversion of the flow of suction air toward the longitudinal axis can be brought about.

Between the third angular position and the fourth angular position, the surface of the diversion element can have a incline with a smaller absolute value in the circumferential direction than between the second angular position and the third angular position. The surface of the diversion element between the third angular position and the fourth angular position can substantially have no incline in the circumferential direction. The angular position can be spaced apart by between 5° and 10° from the third angular position. The provision of a flattened section of the surface at the second edge of the step enables the extent of turbulences of the flow of suction air at the step of the diversion element to be further reduced.

Between the first angular position and the second angular position, the normal vector of the surface of the diversion element can have directional components in the radial direction and in the axial direction in relation to the longitudinal axis (in order to provide the aforementioned angled section of the surface of the diversion element).

On the other hand, the normal vector of the surface of the diversion element between the second angular position and the third angular position can have directional components in the circumferential direction and in the axial direction in relation to the longitudinal axis. Furthermore, the normal vector of the surface of the diversion element preferably has no directional component in the radial direction between the second angular position and the third angular position. The normal vector of the surface of the diversion element can thus subsequently be aligned to the second angular position in parallel with the longitudinal axis. This is advantageous in particular when the diversion element is additionally embodied as an ejection and/or compacting element.

As already stated, the separating unit can include an (annular) ejection and/or compacting element, which is embodied to be moved within the collecting container in order to compress the particles of dirt disposed in the collecting container and/or to eject them from the collecting container. The ejection and/or compacting element can in particular be embodied, (starting from the initial position disposed on the first end face for example) to be moved along the longitudinal axis over the surface of the filter unit (in particular toward the second end face of the collecting container). The ejection and/or compacting element, in the initial position, is preferably disposed in the radial direction (in relation to the longitudinal axis) flush with the first transverse edge of the inlet opening.

The surface of the annular ejection and/or compacting element has an inner edge facing toward the surface of the filter unit, which is embodied to clean the surface of the filter unit when the annular ejection and/or compacting element is moved along the longitudinal axis.

In a preferred embodiment the ejection and/or compacting element is embodied as a diversion element, which has a surface that acts on the flow of suction air. In other words the diversion element can be embodied as an (annular) ejection and/or compacting element. In this way the direction of flow of the flow of suction air can be brought about in an especially efficient way.

With the objects of the invention in view, there is concomitantly provided a suction apparatus, in particular a handheld vacuum cleaner, which comprises the separating unit described in this document. The suction apparatus further includes a fan, which is embodied to bring about a flow of suction air from the suction nozzle of the suction apparatus, through the inlet opening of the separating unit, through the filter unit and to the fan.

It should be noted that any aspects of the separating unit described in this document and the suction apparatus described in this document can be combined in a wide diversity of ways. In particular, the features of the claims can be combined with one another in a wide diversity of ways. The features described in this document for a separating unit can be used individually or in combination in the different variants of the separating unit described.

Other features which are considered as characteristic for the invention are set forth in the appended claims.

Although the invention is illustrated and described herein as embodied in a suction apparatus and a separating unit for a suction apparatus with a helical diversion element, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of an example of a suction apparatus with a suction unit, a suction tube and a nozzle;

FIGS. 2a to 2c are different perspective views of a suction unit and of the separating unit of a suction unit;

FIGS. 3a to 3b are different plan and perspective views of flexible flaps for covering the inlet opening of a separating unit;

FIG. 3c includes a plan view and a side view of a flap;

FIGS. 4a to 4d are different perspective views of a flap resting on the support surface (of the ejection and/or compacting element) of the separating unit;

FIGS. 5a to 5c are different perspective views of an example of an ejection and/or compacting element;

FIG. 5d is a graph showing an example of the course of the height of the edges of the ejection and/or compacting element in the circumferential direction; and

FIGS. 6a and 6b are perspective views of an example of an ejection and/or compacting element with a ramp for aligning the flow of suction air running in the circumferential direction.

### DETAILED DESCRIPTION OF THE INVENTION

As stated at the outset, the present document deals with bringing about an especially advantageous alignment of the cyclonic flow of suction air within the separating unit of a suction apparatus, in particular in order, even after a longer period of use of the suction apparatus without emptying the collecting container of the separating unit, to provide a high suction power.

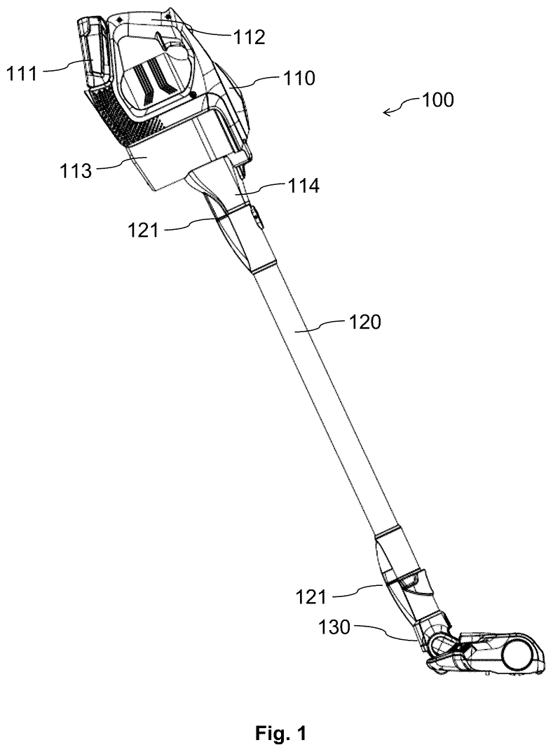

Referring now to the figures of the drawings in detail and first, particularly, to FIG. 1 thereof, there is seen, in this connection, an example of a (handheld) vacuum cleaner 100 (as an example of a suction apparatus), which has a suction unit 110 with an electrical energy storage device 111. The suction unit 110 has a (hand) grip 112, which a user can grip with their hand in order to hold the suction unit 110. A flow of suction air through the suction nozzle 114 of the suction unit 110, via the separating unit 113 of the suction unit 110 to the fan is brought about by the suction unit 110. The suction unit 110 can be embodied to be used independently as a suction apparatus.

An accessory 120, 130 can be connected to the suction unit 110 via a coupling 121. In the example shown the suction unit 110 is connected via a coupling 121 to a suction tube 120, which in its turn is connected via a coupling 121 to a floor nozzle 130.

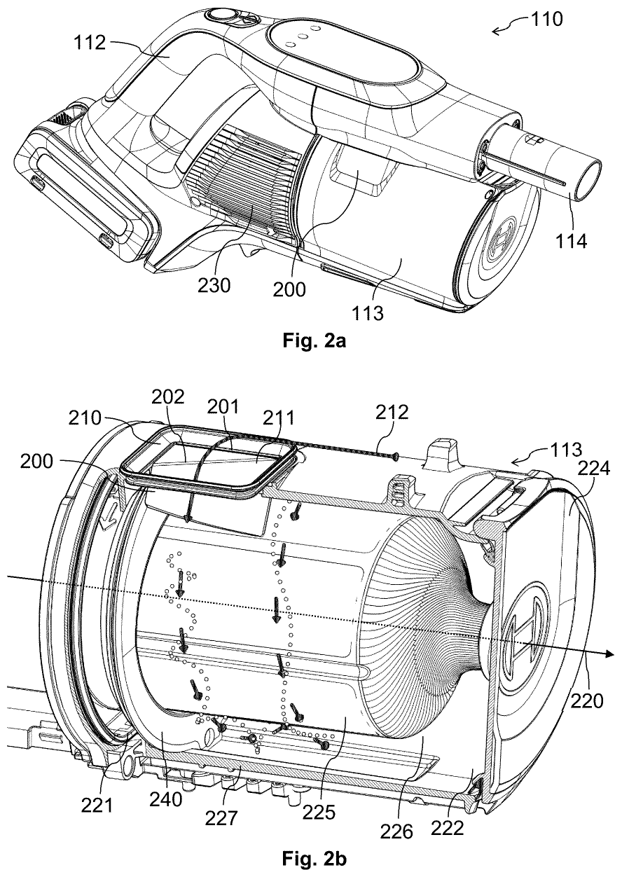

FIGS. 2a to 2c show different views of a suction unit 110 and a separating unit 113. The flow of suction air 212 brought about by the fan 230 is sucked through the suction nozzle 114 of the suction unit 110 into the separating unit 113. The separating unit 113 has an outer housing wall 227, which surrounds a filter unit 225. A collecting container is formed by the housing wall 227. The flow of suction air 212 is sucked through an (inlet) opening 211 formed on the housing wall 227 into the collecting container surrounded by the housing wall 227. In this case the flow of suction air 212, on its introduction into the collecting container, is preferably aligned so that the flow of suction air 212 circulates in the manner of a cyclone around the (circular cylindrical) filter unit 225. The flow of suction air 212 is further sucked through the surface of the filter unit 225 toward the central longitudinal axis 220 of the separating unit 113. In this case the contaminants from the flow of suction air 212 are held back on the surface of the filter unit 22 and remain in the collecting area 226 formed between the filter unit 225 and the housing wall 227.

The (circular cylindrical) collecting container formed by the housing wall 227 extends along the longitudinal axis 220 from a first end face 221 (facing toward the fan 230) to a second end face 222 (facing away from the fan 230). A lid 224 can be disposed on the second end face 222, which covers the collecting container. The lid 224 can be opened (for example pivoted upward), so that contaminants can be removed from the collecting area 226 of the collecting container via the second end face 222.

An ejection and/or compacting element 240, which is embodied to be moved along the longitudinal axis 220, can be disposed within the collecting container. The ejection and/or compacting element 240 can, as shown in FIG. 2b, be embodied as a ring, which is disposed around the filter unit 225. The ejection and/or compacting element 240 can extend in a radial direction (in relation to the longitudinal axis 220) from the surface of the filter unit 225 up to the inside of the housing wall 227.

In an initial state, the ejection and/or compacting element 240 can be disposed on the first end face 221 of the collecting container. Furthermore the ejection and/or compacting element 240 can be embodied to be moved along the longitudinal axis 220 from the first end face 221 toward the second end face 222, so that the contaminants disposed in the collecting area 226 are pushed toward the second end face 222 by the ejection and/or compacting element 240. In this way it can be made possible to compress the contaminants disposed in the collecting area 226 (in the area of the second end face 222), so that the surface of the filter unit 225 is substantially free from contaminants, and thus a high suction power continues to be available. Contaminants can further be pushed by the ejection and/or compacting element 240 in a convenient way along the longitudinal axis 220 via the second end face 222 (and the opened lid 224) out of the collecting container, in order to empty the collecting container.

As shown in FIG. 2b for example, the housing wall 227 of the collecting container has a frame 210, which surrounds the opening 211 to the collecting area 226 of the collecting container. The frame 210 is preferably disposed in this case in the immediate vicinity of the first end face 221 of the collecting container. Disposed within the frame 210 is a flexible flap 200, which is embodied in such a way that the flap 200 closes off the opening 211 surrounded by the frame 210 when no flow of suction air 212 is being produced by the fan 230, i.e. when no forces are acting on the flap 200 in the radial direction from the outside into the collecting container. The collecting container can thus be closed off by the flexible flap 200, so that contaminants being able to fall out of the collecting container through the opening 211 can reliably be avoided, (when the separating unit 113 is disconnected from the suction unit 110 in order to empty the separating unit 113 for example).

The flap 200 can have a pre-tension that presses the flap 200 toward the frame 210. In this way it can be brought about in an especially reliable way that the flap 200 is closed when no flow of suction air 212 is being produced.

The flap 200 preferably is formed of a flexible material (of a flexible plastic for example), so that the flap 200 can be bent away from the frame 210 toward the filter unit 225 under the influence of a force acting from outside on the flap 200 (which can be brought about by the flow of suction air 212 for example) and in this case releases at least a part of the opening 211. This enables the flow of suction air 212 from outside into the collecting container to be brought about.

As can be seen from FIG. 2b, the suction unit 110 can be embodied in such a way that the flow of suction air 212, starting from the suction nozzle 114, initially has a direction of flow that is substantially aligned in parallel with the longitudinal axis 220. At the inlet opening 211 and/or at the frame 210, the direction of flow of the flow of suction air 212 is diverted by approximately 90°, so that the flow of suction air 212 flows in the circumferential direction (and thus substantially at right angles to the longitudinal axis 220) through the inlet opening 211 into the collecting container.

During suction operation the inlet opening 211 is preferably disposed (in relation to the circumferential direction) on the upper side of the housing wall 227 of the collecting container. The enables gravity to act on the contaminants in the flow of suction air 212 in order to convey the contaminants into the collecting container. On the other hand, due to the alignment of the inlet opening 211, it can occur that (in particular relatively large) particles of dirt remain on the outer side of the flap 200 and increasingly collect on the outer side of the flap 200 and possibly lead to a blockage of the inlet opening 211.

The dirt disposed on the outer side of the flap 200 might possibly fall off when the separating unit 113 is disconnected from the suction unit 110, which can be felt to be unpleasant by a user. Suction operation further has to be interrupted if a blockage of the inlet opening 211 is present, and the separating unit must be cleaned, which can likewise be felt to be inconvenient.

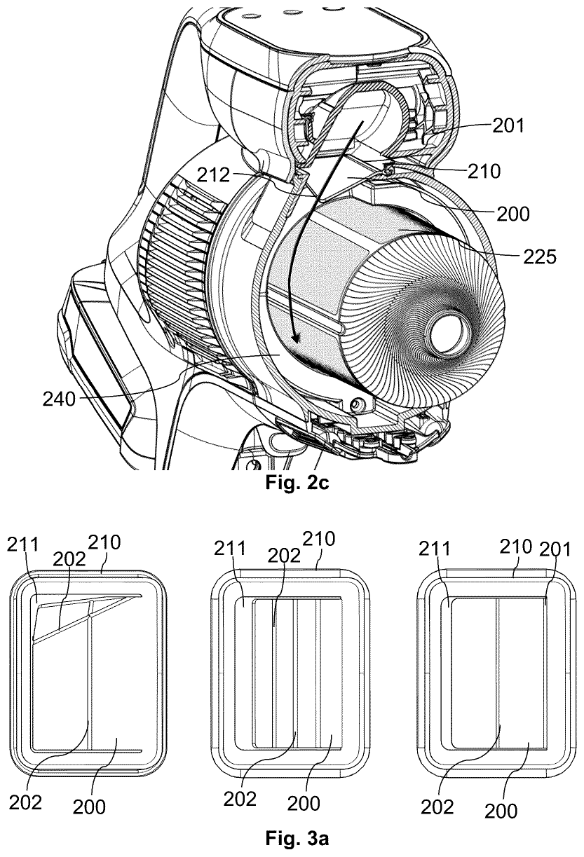

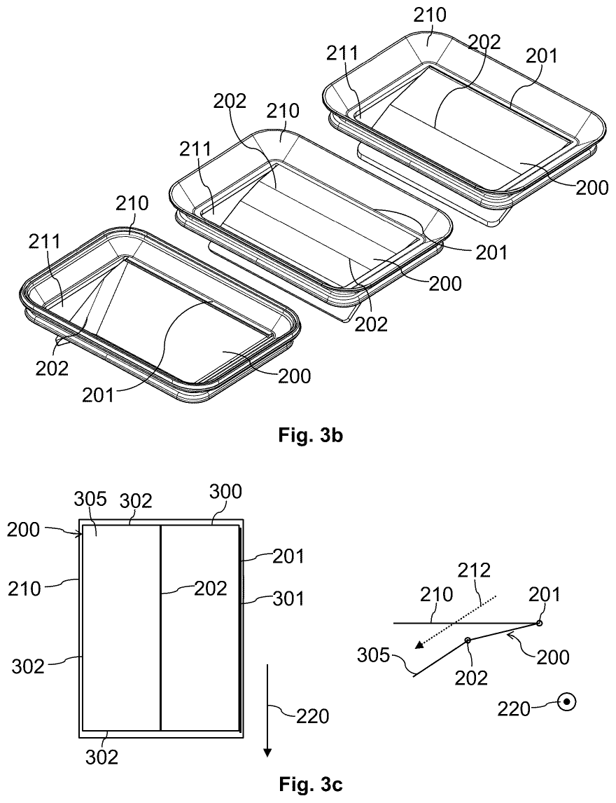

The flap 200 preferably has one of more predetermined bending points 201, 202 (as shown by way of example in FIGS. 3a to 3b), by which the opening angle of at least one partial area of the flap 200 can be increased. A predetermined bending point 201, 202 can be embodied in particular as a (film) hinge. The flap 200 can have a main hinge 201, which runs along a (main) edge of the frame 210, and which makes it possible to open the entire flap 200 (i.e. the entire surface of the flap 200). The flap 200 furthermore has one or more (linear) predetermined bending points 202, which each make it possible additionally to open a respective partial area of the flap 200.

The flap 200 can, as shown by way of example in FIG. 3c, have an overall surface 300, for example a rectangular overall surface, wherein the overall surface 300 completely covers the inlet opening 211. The overall surface 300 is delimited by a main edge 301 and one or more (in particular three) secondary edges 302. The main edge 301 is typically connected permanently to the frame 210 of the inlet opening 211, so that the flap 200 cannot be moved away from the frame 210 at the main edge 301. The one or more secondary edges 302 are not connected to the frame 210 of the inlet opening 211, and can be moved away from the frame 210 (by the action of a radial force) in order to open the inlet opening 211.

A linear main predetermined bending point 201 can be disposed on the main edge 301 (in the form of a film hinge for example), which makes possible a pivoting movement of the overall surface 300 of the flap 200 around the linear main predetermined bending point 201 (i.e. the main bending axis). The hinge angle made possible by the main predetermined bending point 201 is typically restricted (to 45° or less for example, or to 30° or less) so that the overall surface 300 of the flap 200 can only be pivoted open by the force of the flow of suction air 212 to a specific opening angle. This has the advantage that the direction of flow of the flow of suction air 212 through the inlet opening 211 has an especially large directional component in the circumferential direction and only a relatively small directional component in the radial direction. In this way a robust cyclonic flow of suction air 212 within the collecting container of the separating unit 113 can be brought about in a reliable way.

On the other hand, the restriction of the opening angle of the main predetermined bending point 201 at the main edge 301 of the flap 200 can lead to relatively large particles of dirt remaining stuck to the outer side of the flap 200.

The flap 200 can therefore have at least one further (linear) predetermined bending point 202, which makes an additional pivoting or bending of a partial area 305 of the overall surface 300 of the flap 200 around the respective predetermined bending point 202 (i.e. around the respective bending axis) possible. A further predetermined bending point 202 (in particular a further film hinge) thus makes it possible for a partial area 305 of the overall surface 300 (facing away from the main edge 301) to be able to bend away additionally from the frame 210 (in particular under the influence of a relatively large particle of dirt). As a consequence of this, the inlet opening 211 in the corresponding partial area of the inlet opening 211 can be opened further, so that relatively large particles of dirt can also get into the collecting container.

The additional bending away or pivoting away of a partial area 305 of the overall surface 300 of the flap 200 is typically not brought about by a flow of suction air 212 that only has small particles of dirt. In this way it can continue to be guaranteed that the direction of flow of the flow of suction air 212 has a largest possible directional component in the circumferential direction and only a relatively small directional component in the radial direction. On the other hand the additional bending away or pivoting away of the partial area 305 of the overall surface 300 of the flap 200 can be brought about when a relatively large particle of dirt carried along by the flow of suction air 212 acts on this partial area 305 of the overall surface 300 (and in doing so causes a relatively large force in the radial direction).

By the additional inclusion of one or more film hinges 202, which are disposed transversely, longitudinally, diagonally, on the front and/or on the rear side or also in a very wide diversity of combinations on the elastic dust exclusion flap 200, it is thus possible for the flap 200, with relatively large particles and/or with a relatively large amount of dirt in the flow of suction air 212 at least in one or more partial areas 305 of the overall surface 300, to open further and thus for dirt not to remain stuck between the flap 200 and the inlet opening 211 of the collecting container. Further in this case the wall orientation of the air flow 212 (toward the inside of the housing wall 227) continues to be in place for better dust separation. This wall orientation is produced (with relatively high volumes of air) by the main film hinge 201 (which runs along the longitudinal axis 220 for example). With relatively low volumes of air, one or more subsequent further film hinges 202 running longitudinally can bring about the opening (at least of one or more partial areas 305) of the flap 200. In this way, even with a relatively small volume of air, a good wall orientation of the suction air flowing in is guaranteed.

The first end face 221 of the collecting container of the separating unit 113 is typically aligned upward during operation of the suction unit 110, while the second end face 222 of the collecting container is aligned downward. Thus the force of gravity, by which at least a part of the contamination (for example dust particles) are disposed in the collecting area 226, acts during suction operation, by which at least a part of the contamination is moved toward the second end face 222. As a result of this fewer contaminants tend to be disposed in the vicinity of the first end face 221 during suction operation than in the vicinity of the second end face 222. Therefore it is typically advantageous for maintaining a suction power that is as high as possible, for the inlet opening 211 for letting the flow of suction air 222 into the collecting container to be disposed as close as possible to the first end face 221 of the collecting container.

In order to keep the collecting area 226 of the collecting container of the separating unit 113 in the area of the inlet opening 211 as free of contaminants as possible, and in order thereby to provide a permanently high suction power, it is advantageous for the flow of suction air 212 to be embodied helically around the filter unit 225 and to flow toward the second end face 222. For this purpose the flap 200 at the inlet opening 211 can be embodied to align the flow of suction air 212 flowing through the inlet opening 211 in such a way that the directional vector of the direction of movement of the flow of suction air 212 has a first vector component in the circumferential direction and a second vector component in the longitudinal direction 220. The relationship between the first vector component and the second vector component enables the height of the helical direction of flow of the flow of suction air 212 to be defined.

The flap 200 can have one of more (linear) predetermined bending points 202, which make it possible to bend or to hinge one or more partial areas 305 of the overall surface 300 of the flap 200 around a respective (bending) axis, wherein the respective (bending) axis runs at an angle to the longitudinal axis 220. The normal vector at right angles to the bending axis of a predetermined bending point 202 can in particular have a directional component, which is aligned toward the second end face 222 of the collecting container. In this way it can brought about that the flow of suction air 212 steered by the bent partial area 305 of the overall surface 300 of the flap 200 bent around this bending axis toward the second end face 222, so that through this a helical flow of suction air 212 in the collecting container of the separating unit 113 is brought about.

FIG. 2b shows an example of a flap 200 with a (linear) predetermined bending point 202, by which a bending axis is defined, which is aligned at an angle to the longitudinal axis 220 in such a way that the direction of flow of the flow of suction air 212 is aligned (by a specific angle) toward the second end face 222 of the collecting container by the partial area 305 of the flap 200 bent around the bending axis. What this can bring about is that contamination increasingly collects at the second end face 222 of the collecting container, and that the inlet opening 211 remains free for accepting additional contamination. This enables a permanently high suction power to be produced.

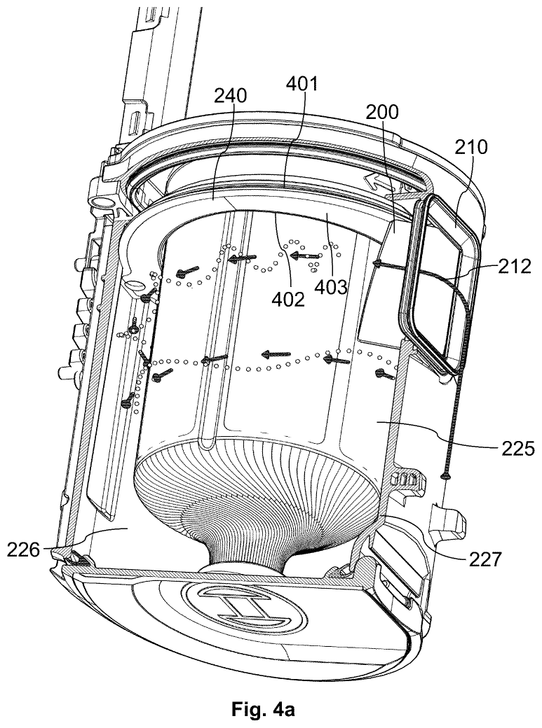

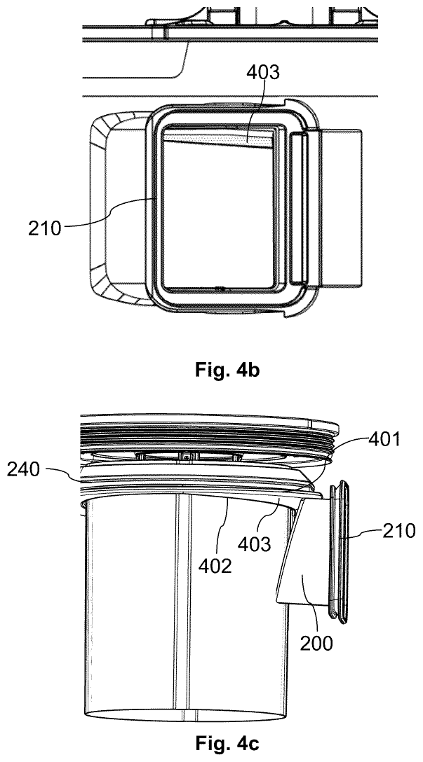

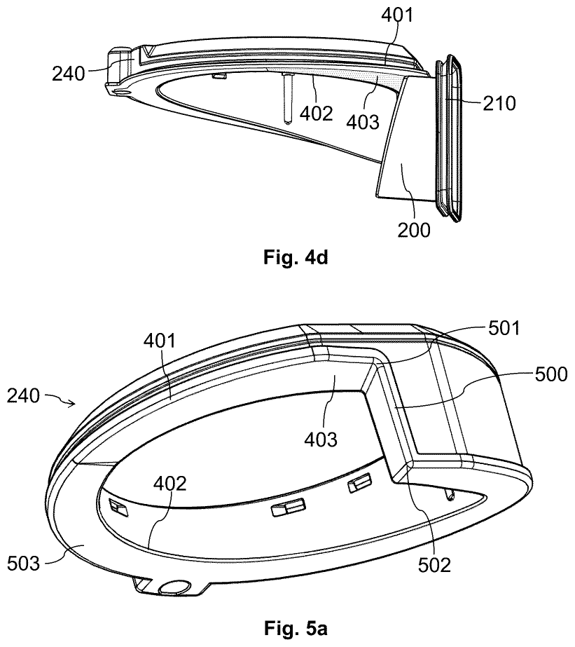

FIG. 4a shows an example of a separating unit 113 with a flexible flap 200, which is pushed away by the action of the flow of suction air 212 from the frame 210 of the inlet opening 211 into the collecting container. The flexible flap 200 is laid down in this case on a support surface 403 within the collecting container. In particular the (first) partial area of the flap 200 facing toward the first end face 221 of the collecting container is laid down on a support surface 403.

The support surface 403 can be embodied in such a way that the flap 200 put down on the support surface 403 has a normal vector (set at right angles to the surface 300 of the flap 200) with a directional component along the longitudinal axis 220. This can in particular be achieved by the support surface 403 having a normal vector that has one directional component along the longitudinal axis and one directional component in the radial direction.

As stated further above, the flow of suction air 212 typically flows in the circumferential direction through the inlet opening 211. As a consequence of this the flap 200 is bent around the main bending axis of the main bending point 201 (running in parallel with the longitudinal axis 220). Without provision of a support surface 403 the normal vectors on the bent surface 300 of the flap 200 would only have directional components in the circumferential direction and in the radial direction. Through the support surface 403, which acts on the (first) partial area 200 of the flap facing toward the first end face 221 of the collecting container, the flap 200 is bent is such a way that the normal vectors of the bent surface 300 of the flap in the put down (first) partial area also have a directional component along the longitudinal axis 220, wherein this directional component faces toward the second end face 222 of the collecting container.

What can be brought about by a flap 200 aligned in such a way is that an impulse on the flow of suction air 212 flowing in through the inlet opening 211 can be imparted by a flap 200, which turns the direction of flow of the flow of suction air 212 (at least slightly) toward the second end face 222 of the collecting container, so that the direction of flow, as well as a directional component in the circumferential direction, also has a directional component along the longitudinal axis 220 (toward the second end face 222). In this way a helical flow of suction air 212 within the collecting container can be brought about in an efficient and reliable way.

The support surface 403 can be provided in an especially efficient way by the ejection and/or compacting element 240. The ejection and/or compacting element 240 can have an outer edge 401 facing toward the inside of the housing wall 227 and an inner edge 402 facing toward the surface of the filter unit 225. The support surface 403 can be formed by the surface of the ejection and/or compacting element 240, which faces toward the second end face 222 of the collecting container and which runs from the inner edge 402 to the outer edge 401 of the ejection and/or compacting element 240. This surface of the ejection and/or compacting element 240 typically serves to push the contaminants in the collecting area 226 of the collecting container toward the second end face 222 of the collecting container.

FIG. 4b shows the support surface 403 in a perspective through the inlet opening 211 of the collecting container. FIGS. 4c and 4d show how the flexible flap 200 lays on the support surface 403 formed by the ejection and/or compacting element 240, and is bent by this toward the second end face 222 of the collecting container.

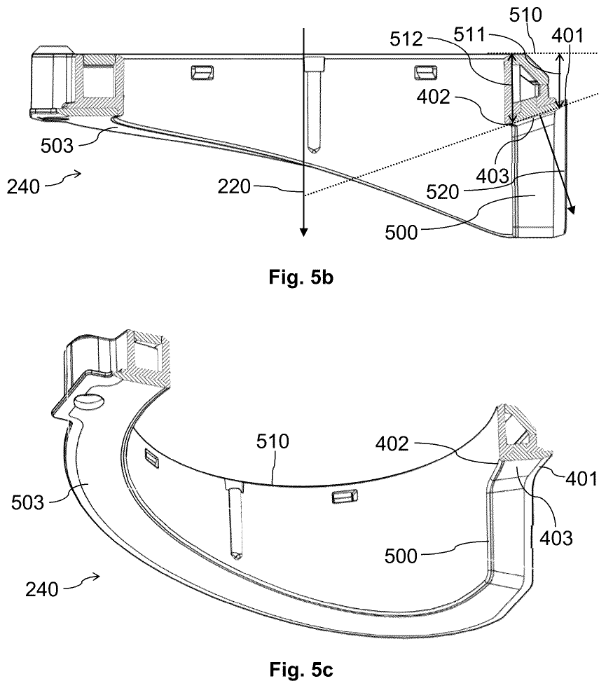

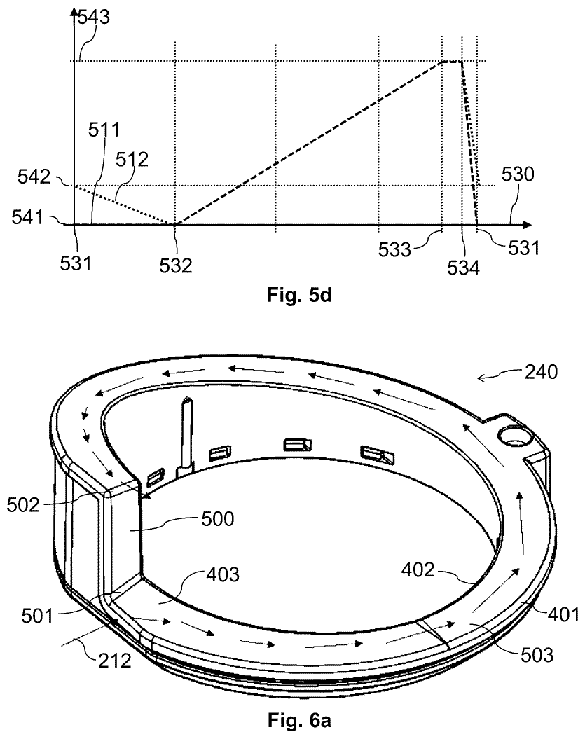

FIGS. 5a to 5c show further details of an example of an (annular) ejection and/or compacting element 240. As can be seen in particular from FIG. 5b, the (annular) surface 503 of the ejection and/or compacting element 240 for providing the support surface 403 for the flexible flap 200 that faces toward the second end face 222 of the collecting container can have an alignment 520 that runs at an angle to the longitudinal axis 220, so that the alignment 520 (i.e. the normal vector) of the surface 503 of the ejection and/or compacting element 240 does not run parallel to the longitudinal axis 220 but has a directional component which points outward in the radial direction.

In the area of the support surface 403 the outer edge 401 of the ejection and/or compacting element 240 can have an outer edge distance 511 from a reference plane 510 (which is aligned at right angles to the longitudinal axis 220). The reference plane 510 can for example correspond to the rear side of the ejection and/or compacting element 240 (facing toward the first end face 221). In the area of the support surface 403 the inner edge 402 of the ejection and/or compacting element 240 can have an inner edge distance 512 to the reference plane 510. The inner edge distance 512 is greater than the outer edge distance 511, so that the support surface 403 running between the inner edge 402 and the outer edge 401 (substantially in a straight line) slopes outward in the radial direction.

As stated further below, the surface 503 of the ejection and/or compacting element 240 facing toward the second end face 222 can be used to directly influence the direction of flow of the flow of suction air 212. It is therefore advantageous to restrict the angled alignment, 520 of the surface 503 of the ejection and/or compacting element 240 to the partial area (in particular to the angular area) of the ejection and/or compacting element 240 that is disposed in the radial direction directly below the inlet opening 211. In other partial areas (in particular in other angular areas) of the ejection and/or compacting element 240 it can be advantageous to align the surface 503 in parallel with the longitudinal axis 220.

FIG. 5d shows an example of a distance 511 of the outer edge 401 (dashed) and an example of a distance 512 of the inner edge 402 (dotted) as a function of the angular position 530 around the longitudinal axis 220. The angled support surface and/or the angled section 403 is provided in the angular area between the first angular position 531 and the second angular position 532. In this case the alignment 520 of the surface 503 of the ejection and/or compacting element 240 changes fluidly from a maximum angle (for example 20°) relative to the longitudinal axis 220 (at the first angular position 531) to a parallel arrangement in relation to the longitudinal axis 220 (at the second angular position 532). This is advantageous for a guidance of the flow of suction air 212 brought about by the surface 503 of the ejection and/or compacting element 240. As from the second angular position 532, the alignment 520 of the surface 503 of the ejection and/or compacting element 240 can be aligned substantially in parallel with the longitudinal axis 220.

As can be seen from FIG. 5d, the outer edge 401 between the first angular position 531 and the second angular position 532 has a first distance value 541 that stays the same in relation to the reference plane 510. On the other hand, the inner edge distance 512 of the inner edge 402, starting from a relatively high second distance value 542 (at the first angular position 531) reduces fluidly (possibly linearly) to the first distance value 541 (at the second angular position 532).

A spiral-shaped flow of suction air 212 can be brought about by the flap 200 resting at an angle, which is aligned facing toward the second end face of the collecting container. As a consequence of this, the volume flow of the flow of suction air 212 that acts on the rear side of the flap 200 and thereby brings about a closing force for closing the inlet opening 211 can be reduced. As a consequence of this the effective degree of opening of the inlet opening 211 can be increased, by which the flow resistance of the inlet opening 211 is reduced, and by which the suction power is increased.

What can further be brought about by the spiral-shaped flow of suction air 212 is that contaminants are conveyed toward the second end face 222 of the collecting container, and thus do not reach the first end face 221 behind the ejection and/or compacting element 240.

The angled support of the flap 200 on a support surface 403 of the ejection and/or compacting element 240 makes it possible for the ejection and/or compacting element 240 also to be actuated during operation of the suction unit 110 in order to compress contaminants (without having to switch off the fan 230). In this way the convenience of the suction unit 110 can be further increased.

Thus an improved separation performance is brought about for a centrifugal separator 113. This can be achieved in particular by a spiral-shaped flow of air being created around the filter after the flow or air 212 has passed through the inlet opening 211.

In a centrifugal separator 113 for a vacuum cleaner 100, in which the inlet 211 is covered by a movable (preferably one-piece) elastic flap 200, the flap 200 can have two (preferably contiguous) partial areas, an upper (i.e. first) partial area (in relation to the longitudinal axis 220) and a lower (i.e. second) partial area. The flap 200 is opened by the sucked-in air 212. In this situation the upper partial area or the upper edge of the flap 200 is touching an obstacle (for example an angled section on the wiping ring 240). Through this the flap 200 is opened asymmetrically (no complete cross-sectional opening) in relation to the longitudinal axis 220 (seen through the air flow 212), so that the flow of air 212, through angled position of the flap 200 in the upper partial area of the flap 200 (which faces toward the first end face 221) experiences at least a spiral movement downward (toward the second end face 222 of the collecting container). In other words, not only does a spiral-shaped flow of air arise at right angles to the longitudinal axis 220 around the axis, but additionally also a spiral-shaped swirl or impulse in the direction of the air flow. Thus not only does a flow or air around the inner filter unit 225 arise, but also a swirl and/or an impulse in the direction of the suction flow. This enables particles of dirt to better reach the inside of the housing wall 227 of the collecting container, so that the degree of separation is improved.

Thus a centrifugal separator (i.e. a separating unit) 113 with an inlet 211 is described, which is covered by a movable elastic flap 200. The centrifugal separator 113 further has an obstacle (in the form of a support surface 403 for example), which restricts the opening movement of the flap 200 at the upper or first edge (facing toward the first end face 221 of the collecting container).

The flap 200 can be disposed in a resting position between the inlet opening 211 and the centrifugal separator 113. The inlet opening 211 and the flap 200 can be embodied in an approximately rectangular shape in each case. The obstacle can be disposed in or on the centrifugal separator 113. The obstacle can in particular be formed by the wiping ring 240 (where necessary with an angled section at the inflow area).

As is stated in connection with FIG. 5d, the surface 503 of the ejection and/or compacting element 240 can have an angled section 403, in which the normal vector of the surface 503 runs at an angle to the longitudinal axis 220. The angled section 403 can serve, at least in some areas, as a support surface for the flap 200. The ejection and/or compacting element 240 can generally be considered as a diversion element, which is embodied to divert, at least partly the flow of suction air 212 entering into the collecting container. It should be pointed out that the aspects described in this document in relation to an ejection and/or compacting element 240 are generally applicable to diversion element.

The normal vector of the angled section 403 of the surface 503 can have a directional component in a radial direction outward (from the collecting container). The normal vector of the angled section 403 of the surface 503 can further have a directional component in the axial direction along the longitudinal axis 220 toward the second end face 222 of the collecting container. The angle between the longitudinal axis 220 and the normal vector of the angled section 403, starting from a maximum value (for example 20°) at the first angular position 531 can be reduced fluidly to 0° at the second angular position 532. The second angular position 532 can be spaced apart by 90° in the circumferential direction from the first angular position 531. Such a course of the surface 503 enables a helical flow of suction air 212 to be bought about within the collecting container in an especially reliable and efficient way.

As can be seen in particular from FIG. 5d, the surface 503 of the ejection and/or compacting element 240 (of the diversion element in general) can be embodied in such a way that the distance value of the inner edge distance 512 and of the outer edge distance 511 (i.e. of the distance of the surface 503 of the ejection and/or compacting element 240) from the reference plane 510, increases as the angular position 530 increases, so that a spiral-shaped ramp is provided in the circumferential direction. In the example shown in FIG. 5d, the distance 511, 512 of the surface 503, as from the second angular position 532 to the third angular position 533, starting from the first distance value 541, increases fluidly (with a constant increase in the circumferential direction for example) to a third distance value 543. The third distance value 543 can for example be greater by up to 20% of the overall length of the collecting container (along the longitudinal axis 220) than the first distance value 541. The third angular position 533 can for example correspond to an angle of between 340° and 360°. The provision of a ramp-shaped surface 503 enables the direction of flow of the flow of suction air 212 entering into the collecting container to be changed in an especially reliable way in order to bring about a helical spiral-shaped flow of suction air 212.

In the example shown in FIG. 5d, the surface 503 optionally has a constant value between the third angular position 533 and a fourth angular position 534 of the third distance value 543. The fourth angular position 534 can for example be spaced at between 2° and 10° from the third angular position 533. The provision of an area of the surface 503 flattened out in this way enables the incline of the ramp-shaped surface 503 and the height (along the longitudinal axis 220) of the step 500 formed thereby to be set in a flexible way, in order to bring about an optimized change of the direction of flow of the flow of suction air 212.

Between the fourth angular position 534 and the first angular position 531 the distance value of the distance 511, 512 of the surface 503 is reduced relatively abruptly to the first distance value 541 (at the outer edge 401) or to the second distance value 542 (at the inner edge 402), so that a step 500 arises. An angular distance of 1° or more, in particular of 3° or more, preferably lies between the fourth angular position 534 and the first angular position 531, so that
the step 500 has a negative incline, with an absolute value that is smaller than infinite; and/or
the normal vector of the surface 503 in the area of step 500 has a specific angle (for example of 1° or more, in particular of 3° or more) compared to the transverse plane of the collecting container at right angles to the longitudinal axis 220; and/or
the surface 503 in the area of the step 500 has a specific angle (for example of 1° or more, in particular of 3° or more) compared to the longitudinal axis 220.

The first (lower) edge 501 of the step 500 can be disposed at the first angular position 531, and the second (upper) edge 502 of the step 500 can be disposed at the fourth angular position 534. The surface 503 can substantially run in a straight line between the first edge 501 and the second edge 502. In particular the inner edge 402 and the outer edge 401 between the first edge 501 and the second edge 502 can each run substantially in a straight line.

Thus an ejection and/or compacting element 240 (in general a diversion element) with a ramp-shaped and/or spiral-shaped surface 503 can be provided. In this case the step 500 of the surface 503 can run at a slight angle. Thus, in a reliable way, a rupture in the flow of suction air 212 at the second (upper) edge 502 of the step 500 can be avoided in order to bring about a high separation quality of the separating unit 113.

As already stated, the separating unit 113 can thus have a wiping ring 240 (i.e. an ejection and/or compacting element), which in the area of the inlet opening 211 of the collecting container has a specific incline (for example approximately 20°) compared to a reference plane 510 (wherein the reference plane 510 is disposed at right angles to the longitudinal axis 220). The incline of the surface 503 compared to the reference plane 510 can be present in the radial direction. The surface 503 of the wiping ring 240 can thus have an angled section 403.

The first edge 501 of the ejection ring 240 can be disposed flush with the transverse edge of the inlet opening 211 (facing toward the first end face 221 of the collecting container). The angled section 403, starting from the first edge 501 of the ejection ring 240, can further extend in a circumferential direction over a specific angular area. Through this angled surface 403 the inflowing air 212 undergoes a diversion toward the second end face 222, by which a monocyclone directed toward the second end face 222 arises within the collecting container.

The wiping ring 240 is preferably formed so that the surface 503 of the wiping ring 240 has the inclination only in the area of the inlet opening 211 (for example restricted to an angular area of 90°). Apart from the angled section 403, the surface 503 of the wiping ring 240 can run within the transverse plane of the collecting container (which is disposed at right angles to the longitudinal axis 220).

The angled section 403 and the monocyclone directed toward the second end face 222 brought about by it enable the flow of suction air 212 to be guided explicitly to the second end face 222, by which an improved dirt separation and fewer eddies in the flow of suction air 212 arise. The flow of air toward the first end face 221 is further reduced, so that a depositing of particles of dirt on the rear side of the ejection ring 240 can be avoided.

The angled section 403, when an optional flap 200 is used at the inlet opening 211, enables a reliable closure of the flap 200 to be brought about.

As already stated, the surface 503 of the wiping and/or ejection ring 240 preferably does not have an angled position over its entire extent, but only within the angled section 403. This can bring about that the wiping and/or ejection ring 240 continues to have a lift that is a great as possible along the longitudinal axis 220 in order to eject particles of dirt from the collecting container.

Thus, possibly in addition to a helical air guidance, a swirl or impulse can be brought about in order to achieve a helical air guidance within the collecting container. For this purpose the spiral-shaped surface 503 on the wiping ring 240 can be inclined in the inflow area of the collecting container (i.e. at the inlet opening) compared to the transverse plane (disposed at right angles to the longitudinal axis 220) by approximately 20° (radially outward). In this arrangement the incline preferably falls, after a quarter circle for example, back down to 0°. Preferably the inner delimitation line (i.e. the inner edge 402) of the (air guidance) surface 503 is disposed higher (in relation to the longitudinal axis 220) by comparison with the outer delimitation line (i.e. by comparison with the outer edge 511).

In this way the suction air 212 can be explicitly guided to the spiral-shaped surface 503, wherein in addition a swirl or an impulse to the suction air 212 along the flow of air is created. An improved separation of dirt particles can be achieved by the separating unit 113 in this way.

In one example the incline can extend over the entire spiral-shaped surface 503. In other words, the angled section 403 can extend over the entire surface 503 and over the entire angular area (of 360°) in order further to strengthen the impulse on the flow of suction air 212 in the direction toward the second end face 222 of the collecting container.

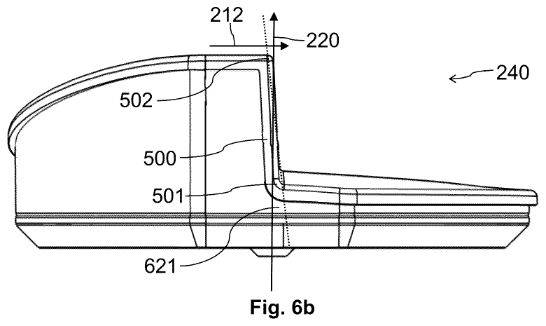

FIGS. 6a and 6b show examples of the step 500 of the ramp-shaped surface 503 of the ejection and/or compacting element 240. As shown in FIG. 6b, the surface 503 on the step 500 preferably has a specific angle 621 (between 1° and 7°, roughly 5° for example) in relation to the longitudinal axis 220. Eddies in the flow of suction air 212 at the second (upper) edge 502 of the step 500 can thus be avoided in a reliable way, by which the separation performance of the separating unit 113 is further increased.

The ejection ring 240 can thus be provided with a ramp in the circumferential direction, by which the dust and/or dirt entering can be conveyed toward the second end face 222 of the collecting container. In this way the efficiency of the suction apparatus 100 and the dust loading of the collecting container of the separating unit 113 can be positively influenced.

The step 500 of the ejection ring 240 following the ramp preferably has an angled wall (in relation to the longitudinal axis 220), wherein the wall of the step 500 is preferably disposed in the circumferential direction directly before or directly on (the first transverse edge) of the inlet opening 211 of the collecting container. For example an angled position of the wall (of the step 500) of approximately 95° relative to the transverse plane (standing at right angles to the longitudinal axis 220) can be brought about. An angled wall enables the rupture of the flow of suction air 212 in this area to be prevented and thereby eddies and thus negative influences on the efficiency and the dust loading of the separating unit 113 to be produced.

The wall (of the step 500) can be rounded at the first (lower) edge 501 and/or at the second (upper) edge 502 (with a specific radius). In this way eddies in the flow of suction air 212 can be avoided in an especially reliable way.

Thus a movable wiping and/or ejection ring 240 for a cyclone filter (i.e. for a filter unit 225) in a vacuum cleaner 100 is described, wherein the wiping and/or ejection ring 240 has a spiral-shaped inclined (air guidance) surface 503. At the end of the incline, at the point at which the spiral offset by the incline meets itself again, an edge surface (i.e. a step 500) is embodied, wherein this edge surface is not at a right angle to the cross-sectional surface of the cyclone filter (i.e. of the filter unit 225), but is sloped between 93° and 98°, preferably 95°. In this way breaks in the flow at the jump in height (i.e. at the step 500) can be avoided in a reliable way. In this way the efficiency of a vacuum cleaner 100, in particular in relation to its dust separation, can be improved. The dust loading of the collecting container of the vacuum cleaner 100 can further be improved in this way.

The step 500 (i.e. the angled wall) preferably has rounding radii at the respective surface ends of the angled wall (i.e. at the first edge 501 and/or at the second edge 502 of the step 500).

The surface normals (i.e. the normal vector) of the angled wall (i.e. of the step 500) can be aligned at right angles to the longitudinal axis 220 (in particular in parallel with a radial direction). As an alternative, the surface normals of the wall can be aligned at an angle of 0° to +−30° to the right angles of the longitudinal axis 220.

At the beginning and/or at the end of the angled wall (i.e. of the step 500) the (air guidance) surface 503 (in the circumferential direction) can have a plane with no incline. As an alternative or in addition the (air guidance) surface 503 can have a continuous or a discontinuous course of the incline of the spiral or of the helix.

The inner edge 402 of the (air guidance) surface 503 preferably has a relatively small distance (of approximately 1 mm for example) to the surface of the filter unit 225.

Through the measures described in this document, it is possible to bring about an improvement in the efficiency, in particular of the dust separation, of a suction unit 110. Furthermore, it is possible to bring about an optimization of the dust loading of the collecting container of a separating unit 113.

The present invention is not restricted to the exemplary embodiments shown. It should be noted in particular that the description and the figures are only intended to illustrate the principle of a separating unit 113 and/or of a suction apparatus 100.

The following is a summary list of reference numerals and the corresponding structure used in the above description of the invention:
100 Suction apparatus (wet-and-dry vacuum cleaner)
110 Suction unit
111 Electrical energy storage device
112 Grip
113 Separating unit
114 Suction nozzle
120 Accessory (suction tube)
121 Coupling
130 Nozzle
200 (Dust flap) flap
201 Main bending point (film hinge)
202 Further bending point (film hinge)
210 Frame
211 Inlet opening (collecting container)
212 Suction air
220 Longitudinal axis
221 First end face (collecting container)
222 Second end face (collecting container)
224 Cover
225 Filter unit
226 Collecting area
230 Fan
240 Diversion element/ejection and/or compacting element
300 Overall surface (flap)
301 Main edge
302 (Free) edge
305 Partial area (of the overall surface)
401 Outer edge
402 Inner edge
403 Angled section/support surface
500 Step
501 First (lower) edge
502 Second (upper) edge
503 Surface of the diversion element or of the ejection and/or compacting element
510 Reference plane (rear side)
511 Outer edge distance
512 Inner edge distance
520 Normal vector or orientation (surface)
530 Angular position
531, 532, 533, 534 Different angular positions
541, 542, 543 Distance values
621 Angle

1. A separating unit for a suction apparatus, the separating unit comprising:
a housing wall surrounding a collecting container, said housing wall having an inside;
said collecting container extending along a longitudinal axis;
said housing wall of said collecting container running cylindrically or circular cylindrically around said longitudinal axis;
said collecting container having an inlet opening disposed at said housing wall for a flow of suction air;
said flow of suction air entering through said inlet opening into said collecting container having a direction of flow running in a circumferential direction relative to said longitudinal axis;
an annular diversion element having a surface acting on said flow of suction air entering into said collecting container;
said surface of said diversion element at least partly running in a shape of a helix along said inside of said housing wall around said longitudinal axis;
said surface of said diversion element having a step with a first edge and a second edge spaced apart from one another along said longitudinal axis; and
said step of said surface running at an angle relative to said longitudinal axis.

2. The separating unit according to claim 1, wherein said step of said surface is disposed at an angle of between 1° and 7° relative to said longitudinal axis.

3. The separating unit according to claim 2, wherein said angle is between 2° and 6°.

4. The separating unit according to claim 2, wherein said angle is approximately 5°.

5. The separating unit according to claim 1, wherein:
said collecting container extends along said longitudinal axis from a first end face to an opposite second end face;
said surface of said diversion element, at a first angular position relative to said longitudinal axis in a radial direction, is disposed flush with said inlet opening or with an edge of said inlet opening facing toward said first end face; and
said surface of said diversion element, following said first angular position, at an increasing angular distance from said first angular position along said longitudinal axis, is shifted toward said second end face, forming a helical shape of said surface.

6. The separating unit according to claim 5, wherein:
said first edge of said step is disposed at said first angular position;
said second edge of said step is disposed at a fourth angular position; and
said fourth angular position and said first angular position are spaced apart from one another by at least 2°.

7. The separating unit according to claim 6, wherein said fourth angular position and said first angular position are spaced apart from one another by between 2° and 5°.

8. The separating unit according to claim 6, wherein said surface or an outer edge of said surface facing toward said inside of said housing wall substantially runs in a straight line from said second edge at said fourth angular position up to said first edge at said first angular position.

9. The separating unit according to claim 6, wherein:
said collecting container has an overall length from said first end face to said second end face; and
said second edge is spaced apart along said longitudinal axis from said first edge by at least 5% of said overall length.

10. The separating unit according to claim 9, wherein said second edge is spaced apart along said longitudinal axis from said first edge by between 5% and 20% of said overall length.

11. The separating unit according to claim 6, wherein:
said surface of said diversion element, from a second angular position, is displaced from said second angular position with an increasing angular distance to a third angular position along said longitudinal axis toward said second end face, forming said helical shape of said surface;
said second angular position is spaced apart from said first angular position by between 70° and 110°; and
said third angular position is spaced apart from said first angular position elevated by 360°, by between 1° and 15°.

12. The separating unit according to claim 11, wherein said second angular position is spaced apart from said first angular position by approximately 90°.

13. The separating unit according to claim 11, wherein said surface of said diversion element has a constant incline staying constant in the circumferential direction between said second angular position and said third angular position.

14. The separating unit according to claim 11, wherein:
said surface of said diversion element has an incline with a smaller absolute value in the circumferential direction between said third angular position and said fourth angular position than said surface has between said second angular position and said third angular position;
said surface of said diversion element has substantially no incline in the circumferential direction between said third angular position and said fourth angular position; and
said fourth angular position is spaced apart from said third angular position by between 5° and 10°.

15. The separating unit according to claim 11, wherein said surface of said diversion element has a normal vector with at least one of:
directional components in the radial direction and in an axial direction relative to said longitudinal axis between said first angular position and said second angular position; or
directional components in the circumferential direction and in the axial direction relative to said longitudinal axis between said second angular position and said third angular position.

16. The separating unit according to claim 15, wherein said directional components in the circumferential direction and in the axial direction relative to said longitudinal axis between said second angular position and said third angular position have no directional component in the radial direction.

17. The separating unit according to claim 1, wherein said surface of said diversion element is rounded at least at said first edge or said second edge in the circumferential direction.

18. The separating unit according to claim 1, wherein:
said diversion element is at least one of an annular ejection or compacting element having said surface acting on said flow of suction air; and
said at least one of an annular ejection or compacting element is configured to be moved within said collecting container along said longitudinal axis to at least one of compress the particles of dirt disposed in said collecting container or eject the particles of dirt from said collecting container.

19. The separating unit according to claim 17, which further comprises:
a filter unit disposed in said collecting container, said filter unit having a surface;
said surface of said at least one of an annular ejection or compacting element having an inner edge facing toward said surface of said filter unit, said inner edge configured to clean said surface of said filter unit upon said at least one of an annular ejection or compacting element being moved along said longitudinal axis.

20. A suction apparatus, comprising:
the separating unit according to claim 1 having a filter unit;
a fan; and
a suction nozzle;
said fan configured to bring about said flow of suction air from said suction nozzle, through said inlet opening of the separating unit and through said filter unit to said fan.
